(19) United States
(12) Patent Application Publication
(10) Pub. No.: US 2005/0187795 A1
(43) Pub. Date: Aug. 25, 2005

(54) Dynamic safety monitoring in clinical trial

(76) Inventor: Mary Russell, Carlisle, MA (US)

Correspondence Address: KENYON & KENYON, 1500 K STREET NW, SUITE 700, WASHINGTON, DC, 20005, US

(21) Appl. No.: 11/061,456

(22) Filed: Feb. 22, 2005

Related U.S. Application Data
(60) Provisional application No. 60/546,938, filed on Feb. 24, 2004.

(51) Int. Cl. G06F 17/60

(52) U.S. Cl. 705/3

(57) ABSTRACT

A dynamic safety reporting system for clinical trials in which members of an initial review team are sent dossiers describing patient events in a clinical trial as the dossiers are generated. The initial review team can be required to complete the review within a predetermined time period, and disagreements among initial review team members can be referred to a follow-up review team. Case reports that include the results of the review can be stored in database.

### FIELD OF THE INVENTION

The field of the invention is safety monitoring, and in particular dynamically monitoring data pertaining to the safety of a medical device, procedure, or therapeutic agent during a clinical trial.

### BACKGROUND OF THE INVENTION

Regulatory approval of a medical device, procedure, or therapeutic agent (hereinafter, “medical product or procedure”) product can require a clinical trial. The purpose of the clinical trial is to produce data for determining the safety and efficacy of the medical product or procedure. A clinical trial can be considered to have two phases: an active phase, during which the medical product or procedure is actually tested; and an analysis phase, during which the data from the active phase is analyzed and interpreted. During the active phase, clinical staff (“investigators”) use the product or procedure to treat or diagnose patients and monitor the results. Typically, the product or procedure is used at a variety of geographical sites, e.g., at numerous hospitals or other medical facilities across the country.

Investigators record and report pertinent data such as characteristics of the patient, the details of the product or procedure dosage used for that patient, changes in the patient's health during and/or after the product or procedure is used, etc. Particular attention is often paid to changes in the health of the patient that can be attributed to the product or procedure being studied. In particular, clinical staff are required to report certain events or effects that may relate to the safety of the device or procedure, e.g., events or effects where the health of a patient participating the trial deteriorates for reasons that may be related to the use of the product or procedure. For medical device trials, for example, regulations of the U.S. Food and Drug Administration (“FDA”) have required investigators to report any “unanticipated adverse device effects” occurring during an investigation to the trial sponsor and a reviewing Institutional Review Board (“IRB”). 21 C.F.R. § 812.150(a)(i). For example, in a clinical trial of a coronary stent, an adverse event (“event”) may be a myocardial infarction, an embolism, death, etc. A list of adverse events that must be reported is specified in advance for the clinical trial.

An investigator records a set of data for each event, generally on a form with specified fields for data collection. Such data may include a description of the event, an indication of the intensity of the event, etc. The investigator may also report preliminary findings regarding the causes of the event, and in particular whether the event was related to the product or procedure that is the subject of the trial. For example, the investigator can indicate whether the event was “probably related”, “possibly related”, or “not related” to the use of the product or procedure, and can include a brief description of her rationale in reaching her conclusion.

The investigator's report is sent to the safety office designated by the sponsor, which may be, for example, an internal office of the sponsor or an external office, e.g., of a contractor. The safety office handles any necessary reporting to the FDA, other agencies and entities, etc. The safety office can also generate a “dossier” that includes information about the event. As used herein, a “dossier” can be a report of data related to a clinical event that provides sufficient information to form at least an initial understanding of how the event relates to the use of the product or procedure.

The dossiers are reported to a panel of experts (typically physicians) called a Clinical Events Committee (“CEC”). The CEC provides an unbiased view of the event, since the CEC is independent both from the investigators and the product's sponsor. Also, the CEC provides uniformity in judgments about events since it is a single group reviewing data collected from numerous sites initially evaluated by different investigators.

Each event is “adjudicated” by the CEC, which uses the dossier to generate a case report. The case report generally will indicate the CEC's conclusion as to whether the event was caused by the product or procedure being investigated. The CEC's conclusions may agree or disagree with the investigator's preliminary findings. The CEC's case report is entered into a clinical trial database, which can be used by regulators in assessing the safety and efficacy of the product or procedure and determining whether to approve it for manufacture, sale and/or use. The members of the CEC have met in person to adjudicate dossiers, typically at the end of clinical milestones, e.g., once every few weeks or months. While dossiers are produced as events arise, in certain known systems, they accumulate until the CEC is ready to meet and review them. Thus, there can be a delay between the time a particular dossier is produced and the time it is adjudicated by the CEC. CEC members are paid for each meeting that they attend to adjudicate cases.

FIG. 1 shows a process of dossier adjudication in accordance with the prior art. An event occurs in the trial 101, and a dossier that can include a preliminary analysis of the event is generated, 102. The dossier is added to a collection of dossiers awaiting review by the CEC, 103. If a trial milestone at which the CEC reviews the dossiers is reached, 104, then the CEC meets and reviews the accumulated dossiers, 105, and reports the results in case reports, 106. As used herein, a “trial milestone” can be the completion of all or a part of the trial, the expiration of a predetermined time period, the arrival of a date certain, etc. If a trial milestone is not reached at step 104, then the dossiers continue to accumulate, 107, until a trial milestone is reached so that the CEC meets and reviews them. The case reports are then committed to a clinical trial database, which can be used by the sponsor and/or regulator.

Although study protocols require prompt reporting of a safety event by an investigator (typically within 24 hours of the event's occurrence), the CEC typically adjudicates the event and generates the case report months or even years later, e.g., upon the completion of the study. As a result, there can be a substantial delay between the time that an event is first reported and the time that evaluated event information is added to the clinical trial database. There is thus a substantial delay in feedback to the product sponsor and regulators, often precluding corrective and/or preemptive action that needs to be taken in the study.

### BRIEF DESCRIPTION OF THE DRAWINGS

FIG. 1 shows an embodiment of the prior art.

FIG. 2 shows a method in accordance with an embodiment of the present invention.

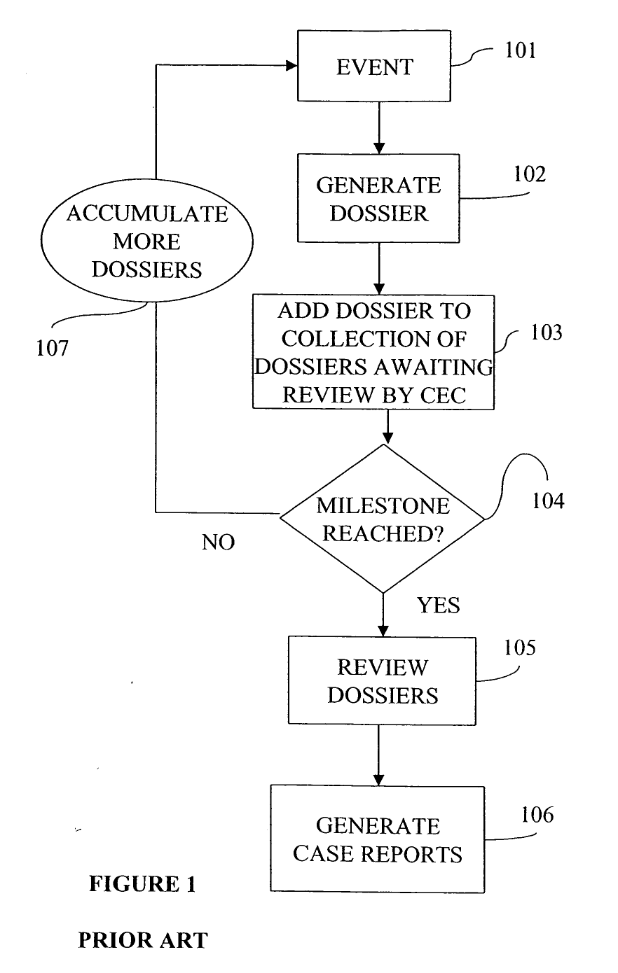

### DETAILED DESCRIPTION

The present invention can provide a system and method for allowing a quicker review or adjudication of events, without the need to wait for milestone-triggered in-person meetings of reviewers or adjudicators. In accordance with an embodiment of the present invention, dossiers are sent as they are generated members of the CEC, who can separately and asynchronously review them. This can provide adjudicated results to the regulator and/or sponsor earlier and in a continuous manner that, unlike in certain known schemes, permits the regulator and/or sponsor to take corrective and/or preemptive actions that protect the health and welfare of the study participants. Further, this quicker provision of adjudicated results can afford the opportunity to make a quicker, more accurate go or no-go decision with respect to the therapy that is the subject of the study. This can save money by avoiding the expense of continuing the study after the data indicates that the therapy is not suitable. It also enables, if necessary, changes to be made more quickly to the product, procedure and/or the trial based upon the results. In this way, regulators and sponsors can act more quickly to address any safety issues that may arise with regard to the product, procedure and/or trial.

In accordance with an embodiment of the present invention, the dossiers can be sent as they are generated to one or more members of the CEC electronically, and each such member can asynchronously review the dossiers and submit his or her results electronically. Due to patient confidentiality, trade secret and/or other considerations, the dossiers can be distributed securely, e.g., encrypted, via SSL-secured download via a web site, etc. A member can be required to authenticate himself to a server storing a dossier before he can obtain a copy, e.g., by providing a userid and a password, by using a secure token to be authenticated by a trusted third party, etc. Alternatively, the dossier's can be sent to one or more members via any other suitable means of communication that can afford rapid delivery, e.g., overnight courier, fax, express mail, etc.

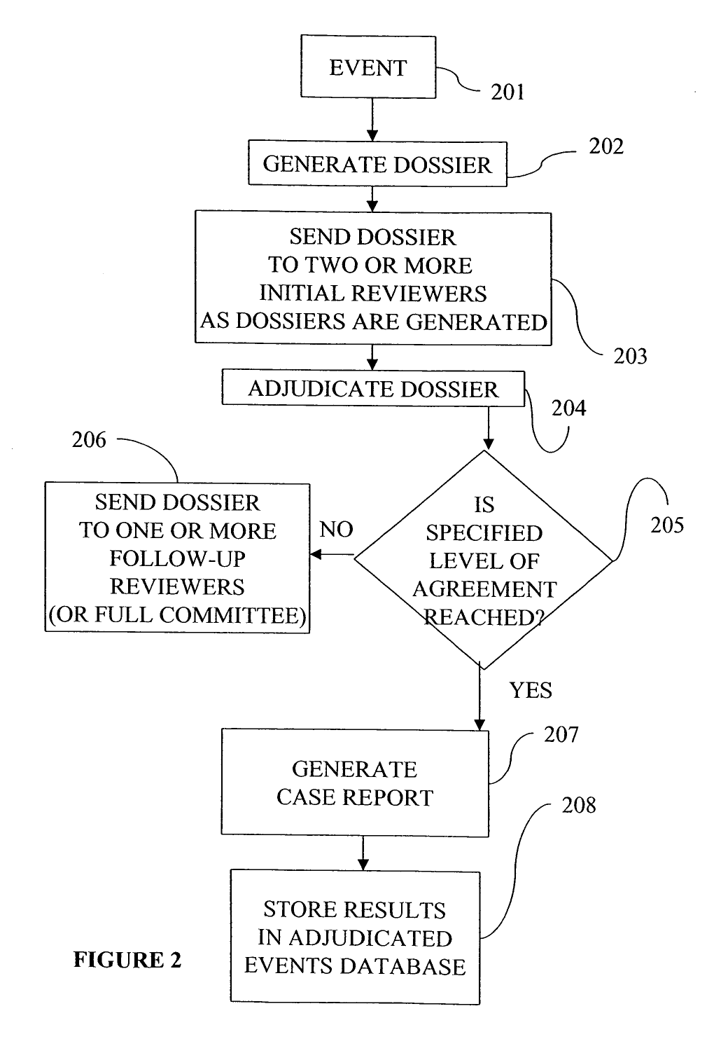

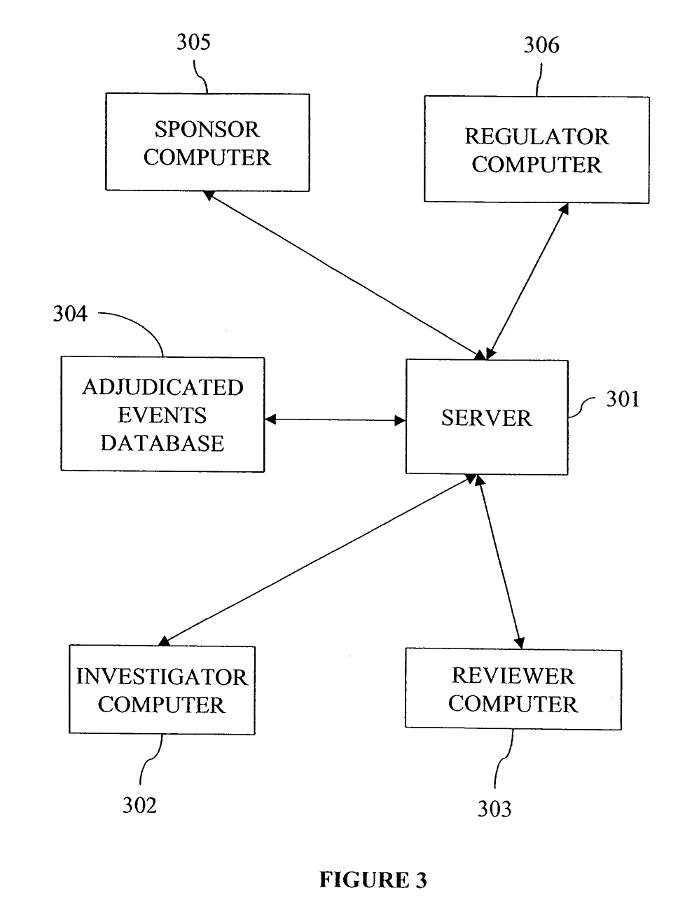

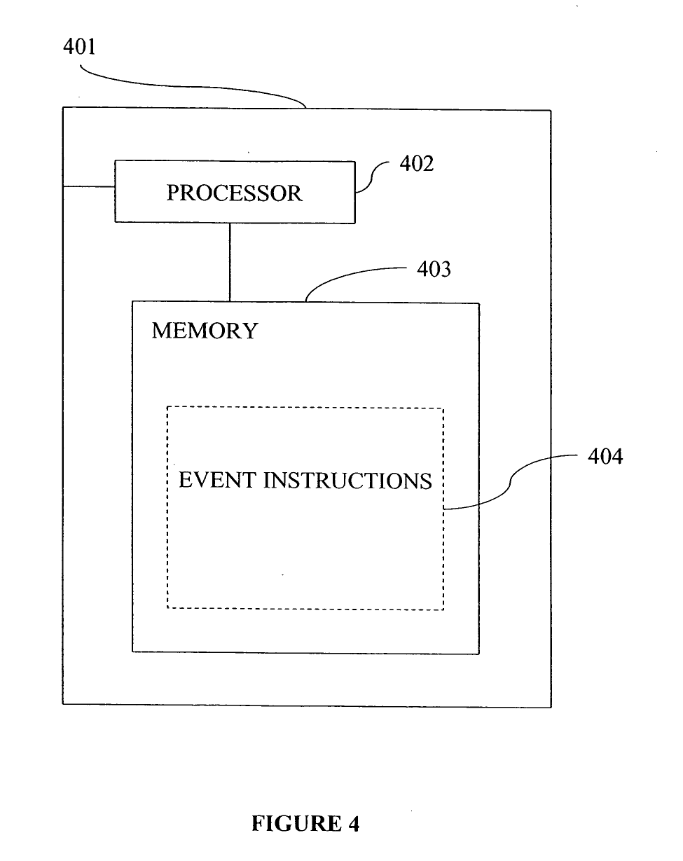

FIG. 2 shows the method in accordance with an embodiment of the present invention. After an event 201, a dossier can be generated, 202. In one embodiment, the dossiers are generated electronically by investigators. As the dossiers are generated, they can be sent to initial reviewers, e.g., two or more members of a CEC, to be reviewed, 203. The dossiers can be sent electronically to reviewing members through a secure extranet, e-mail, etc. A notice can be sent (e.g., e-mail, page, telephone call, etc.) to each such reviewer indicating that a dossier is waiting to be reviewed. A reviewer can then log on, e.g., to an extranet, and retrieve the dossier for review. In one embodiment, the dossier can be a document, e.g., in PDF format. In another embodiment, the dossier can be a collection of web pages, which can include objects such as text, graphs, radiological images, sound clips, video clips, etc.

Each initial reviewer may be given a predetermined amount of time (for example, 24 hours, 48 hours, etc.) or a date certain (e.g., Apr. 14, 2003) by which to complete her review. Further, the set of initial reviewers chosen to review a dossier (the “initial review team”) can be given a predetermined amount of time or a date certain by which a final case report should be submitted. In reviewing a dossier, the reviewers can be required to determine if an event has occurred, the type of event, the cause or causes of the event, etc. In this way, a dossier is adjudicated, 204. A rule can be applied to determine the next step, depending on the outcome of the reviews. For example, a pre-set level of agreement can be specified, 205, and if that level is not reached, further review can be triggered, 206. For example, if all of the reviewers agree on the above three points (i.e., whether an event occurred, the type of event and its cause), then a case report can be generated, 207, and its data can be added to a database of adjudicated events, 208. If not all of the reviewers agree, then one or more follow-up reviewers can be added to the team, 206, e.g., as a tie-breaker. The use of follow-up reviewers is but one example of any suitable follow-on procedure. For example, in another embodiment, review by another entity (beside the CEC) can be instituted in the event of a disagreement among the initial reviewers.

The required level of agreement, 205, for proceeding to a case report, 207, may be a simple majority of the reviewers, a specified minimum supermajority of the reviewers, a specified minimum plurality of the reviewers, etc. Variations on the number reviewers at steps 203 and 206 are possible. For example, the dossiers may originally be sent to more or less than two initial reviewers. Different levels of dissension may trigger further review, and further review may be made by more than one other follow-up reviewers, e.g., by the entire CEC. One or more members of the CEC may be given veto power over the results of any initial review. In addition, provision may be made for one or more of the reviewers to request review by the full CEC at any time. Similarly, the conclusions of the initial reviewers and/or the follow-up reviewers may also be sent to the sponsor, and the sponsor also may be permitted to request certain types of review, e.g., by the entire CEC. Also, there may be subsequent tiers of review. That is, agreement among the follow-up reviewers may be required, and if not obtained, the dossier can be sent to another group of follow-up reviewers for further analysis. Any suitable scheme can be used to constitute “agreement”, and can be established by an agreed-upon charter for the CEC, which can be promulgated at or near the outset of the study.

A case report is generated based upon the results of the reviews, 207, and committed to a database of adjudicated events, 208. The triggering of further review 206 can adjust one or more of the predetermined times afforded the reviewer(s) and/or the review team to complete their tasks. For example, the deadline for the review team to produce a case report can be extended if not all reviewers initially agree. An ultimate objective of the review team can be to produce a case report that sets forth the overall results of the team's analysis of the event.

In a method in accordance with an embodiment of the present invention, dossiers can be reviewed and events can be adjudicated dynamically as the trial proceeds, without having to wait for periodic milestone-triggered, in-person meetings of the CEC. Further, a member can review a dossier and submit his or her results without having to do so concurrently with other reviewers. In this sense, the reviews can be asynchronous, as opposed to the simultaneous review process known in the prior art. For example, two reviewers can receive a dossier on Monday and be given 48 hours to review it. The first reviewer can review it on Monday and submit the results Monday evening. The second reviewer can review it on Tuesday, and submit the review on Tuesday afternoon. If the results of the reviews agree, then a case report can be generated and added to the database. In this way, each reviewer can work at his or her own convenience within the required time period, and both may, but need not, confer to generate a case report. Similarly, each reviewer can work at his or her own location, and need not meet together physically to generate the case report. Of course, reviewers can confer about a dossier should they so desire in accordance with an embodiment of the present invention, and may meet at the same location.

The initial reviewers and the follow-up reviewer(s) may be different people as the trial progresses. For example, certain people may be designated as the initial reviewers and/or the follow-up reviewers) for a particular case, set of cases or for a particular period of time.

The trial database can include one or more thresholds that are specified in advance of the trial, which, if met, trigger another step, e.g., an emergency meeting of a Data Monitoring Committee (DMC). A purpose of the DMC is to address issues raised by adjudicated data that may require urgent changes in the trial for safety reasons. For example, an unexpectedly high death rate in trial patients may trigger such a meeting to determine if the product or procedure is contributing to the death rate, the magnitude of such a contribution, whether the trial should be changed or halted, etc. The dynamic nature of the adjudication process in accordance with an embodiment of the present invention can cause the DMC to convene more promptly than in certain prior art systems. An embodiment of the present invention can shorten the period between the time a threshold is reached among patients, and the time at which the attainment of that threshold is reported to the DMC. Thus, the overall safety of present and future participants in the trial is enhanced.

It will be appreciated that the continuous CEC review and the continuous input of data to the trial database for possible DMC review in accordance with an embodiment of the present invention reduces or eliminates backlog both at the CEC and the DMC levels. Also, the continuous reviews result in the reviews generally occurring close in time to the event. This can be advantageous for gathering any follow-up data since physicians' or other witnesses' memories will generally be better closer in time to the event.

In accordance with an embodiment of the present invention, CEC members can be paid for each case that they adjudicate, rather than for each meeting that they attend as implemented in certain known schemes. This can provide an incentive to review cases, rather than merely to attend meetings, which may lead to higher productivity of CEC members.

An embodiment of the present invention can be implemented electronically. As shown in FIG. 3, a system in accordance with an embodiment of the present invention can include a server computer 301 that can provide graphical user interfaces through a network to client computers operated by users such as investigators 302 and members of a CEC 303. Server computer 301 can send case report data to an adjudicated events database 304, and can act as an interface between the database 304 and computers operated by a sponsor 305 and/or a regulator 306. The network can be any suitable network such as the Internet; a Local Area Network (LAN); a Wide Area Network (WAN); an extranet; an intranet; etc.

An apparatus in accordance with an embodiment of the present invention is shown in FIG. 4. Server 401 can include a processor 402 coupled to a memory 403 that stores event instructions 404 that are adapted to be executed by processor 402. Processor 402 can be a general purpose microprocessor, such as the Pentium IV processor manufactured by the Intel Corporation of Santa Clara, California. Processor 402 can be an Application Specific Integrated Circuit (ASIC) that can include hardware and firmware adapted to perform at least a part of the method in accordance with the present invention. An example of an ASIC is a Digital Signal Processor (DSP). Processor 402 can also be a distributed system of several processors implemented on several different platforms.

Memory 403 can be any device adapted to store digital information, such as Random Access Memory (RAM); Read Only Memory (ROM); a hard disk; flash memory; a rewriteable compact disc; etc.; or a combination thereof.

Event instructions 404 can be adapted to be executed by processor 402 to perform at least part of the method in accordance with the present invention. For example, event instructions 404 can provide a Graphical User Interface (“GUI”) to an investigator that includes forms which, when completed by the investigator using an investigator client computer (see 302 of FIG. 3), gather information about a patient event. The instructions 404 can receive the information, can format it, and can cause the information to be sent to a CEC member computer (see 303, FIG. 3). The instructions 404 can cause the dossier information to appear at the CEC member computer 303 as, for example, a PDF file, a collection of web pages that include text, images, graphs, etc., or in any suitable format.

Event instructions 404 can also provide a GUI to a reviewer 303 that includes forms that, when completed by the reviewer 303, gather information that comprises a dossier review. The instructions 404 can cause review information from a first reviewer to be shared with other reviewers. Instructions 404 can provide a GUI through which information can be gathered that comprises a case report. Instructions 404 can cause case report information to be stored in a database 304, and can act as an intermediary between clients 302, 303, 305 and 306 and the database 304.

Event instructions 404 can be adapted to be executed by processor 402 to perform at least part of the method in accordance with the present invention. For example, event instructions 404 can be executed by processor 402 to participate in generating a dossier for an adverse event, send the dossier to several initial reviewers for review without waiting for additional dossiers to be generated, or the occurrence of some deadline or milestone, generate a case report based upon input from the reviewers, and store information from the case report in a database.

Part or all of event instructions 404 can be stored on a medium to be distributed, installed and/or executed on a computer. The medium can be a portable physical device, such as a CD-ROM, flash memory, etc. The medium can also be a telecommunications channel that carries the instructions as they are downloaded from a source computer to a destination computer.

The foregoing description is meant to illustrate, and not to limit, the scope of the claimed invention. The examples discussed above make apparent to those of ordinary skill in the art other embodiments that are within the scope of the claims.

1. A method for dynamic safety monitoring of adverse events during a clinical trial, including:
completing a dossier within a predetermined period of time after an event report is completed;
sending the dossier to a plurality of initial reviewers for review during the active phase of the trial;
completing an adjudication of the dossier and generating a case report before the occurrence of at least one subsequent event during the active phases of the trial; and
storing information from the case report in a database.
